(19) United States
(12) Patent Application Publication
(10) Pub. No.: US 2016/0054831 A1
(43) Pub. Date: Feb. 25, 2016

(54) CAPACITIVE TOUCH DEVICE AND METHOD IDENTIFYING TOUCH OBJECT ON THE SAME

(71) Applicant: ELAN MICROELECTRONICS CORPORATION, Hsin Chu (TW)

(72) Inventors: YU-JEN TSAI, Taichung City (TW); I-HAU YEH, Taipei City (TW); HSUEH-WEI YANG, Zhubei City (TW); SHENG-FENG LI, New Taipei City (TW)

(73) Assignee: ELAN MICROELECTRONICS CORPORATION, Hsin Chu (TW)

(21) Appl. No.: 14/816,360

(22) Filed: Aug. 3, 2015

(30) Foreign Application Priority Data
Aug. 21, 2014 (TW) 103128758

(51) Int. Cl. G06F 3/044; G09G 5/00; G06F 3/041; G06F 3/047

(52) U.S. Cl. CPC G06F 3/044; G06F 3/047; G09G 5/003; G06F 3/0418; G09G 2300/0426

(57) ABSTRACT

A capacitive touch device and a method identifying touch object on the touch device read sensing information of multiple traces of a touch panel corresponding to a touch object, in which the sensing information includes a sensing cluster corresponding to a portion on the touch panel touched by the touch object, identify a hover cluster of the sensing information corresponding to a portion adjacent to and surrounding the sensing cluster, determine if the hover cluster meets a first characteristic, and determine that the touch object is a specific touch object when the hover cluster meets the first characteristic. Given the foregoing device and method, a palm rejection operation can be more accurately performed and is also applicable to object detection at corners of the touch panel.

### BACKGROUND OF THE INVENTION

1. Field of the Invention

The present invention relates to a capacitive touch device and a method identifying touch object thereon and, more particularly, to a capacitive touch panel with more accurate detection of palm rejection and a method identifying touch object thereon.

2. Description of the Related Art

Most capacitive touch panels these days support multi-touch feature in consideration of the need of more touch operations. To precisely identify touch objects, more prevention techniques against unintentional touch should be available. For example, in response to the expanding operable touch area on electronic devices, such as mobile phones, tablet computers and the like, frequent events of users' palms inadvertently contacting touch panel because of personal operational habit should be considered as conditions of palm rejection and subsequent operations triggered by the events should be also ignored. As disclosed in Taiwan patent publication no. 201351227 entitled “Operation method for touch panel and electronic apparatus thereof”, a technical method associated with palm rejection is applied to determine if an area of a touch object in contact with the touch panel is greater than a preset value. When the contact area is greater than the preset value, a touch event of palm rejection is determined to occur. It can be seen that size of contact area still plays critical role in conventional palm rejection technique.

To serve as the major criterion, the size of contact area actually fails to precisely determine palm rejection of a touch event because setting the preset value is an uneasy job. As the size of a palm of a user depends on physical shape, age and gender of the user, a common preset value is not appropriate to determine palm rejection from touch events conducted by all users. Despite same user, false rejection may arise from different hand gestures of the user. With reference to FIGS. 10A and 10B, when a user contacts a touch panel with a thumb, a contact area A1 of the thumb generated by a gentle touch is distinct from a contact area A2 of the thumb generated by a heavy touch. As the contact area generated by a heavy touch is larger than that generated by a gentle touch and is close to a contact area touched by a palm, false rejection as a result of palm rejection may occur. Certainly, blind spots exist when the contact area is solely used as a major criterion of rejecting a touch event.

Moreover, sensing information over corners of touch panel is usually insufficient. When a touch object falls on a perimeter or any corner of a touch panel, whether a touch event of palm rejection occurs or not is an even tougher job to determine. Accordingly, accuracy in determining palm rejection over corners of the touch panel is worse than that in other areas of the touch panel.

From the foregoing, conventional capacitive touch panels still have the accuracy problem in the palm rejection technique and a feasible solution to tackle the accuracy issue needs to be further discussed and addressed.

### SUMMARY OF THE INVENTION

An objective of the present invention is to provide a method identifying touch object on a capacitive touch device for accurately determining if a touch object is a specific object according to a specific characteristic corresponding to a touch object in order to enhance accuracy in object detection.

To achieve the foregoing objective, the method identifying touch object on a capacitive touch device has steps of:

reading sensing information of multiple traces of a touch panel of a capacitive touch device corresponding to a touch object, in which the sensing information includes a sensing cluster corresponding to a portion on the touch panel touched by the touch object;

identifying a hover cluster of the sensing information, wherein the hover cluster corresponds to a portion on the touch panel adjacent to but not in contact with the touch object and surrounds the sensing cluster;

determining if the hover cluster meets a first characteristic; and

determining that the touch object is a specific touch object when the hover cluster meets the first characteristic.

After the sensing information on the touch panel is read, the foregoing method not only identifies the sensing cluster corresponding to a portion on the touch panel touched by the touch object but determines if the hover cluster surrounds the sensing cluster, further determines the hover cluster meets the first characteristic, and determines that the touch object generates the sensing cluster when the hover cluster meets the first characteristic. As it is the hover cluster taken as a basis for object identification, result of objection detection does not depend on the palm size such that the accuracy in object identification is enhanced.

Another objective of the present invention is to provide a capacitive touch device capable of accurately performing palm rejection operation and enhancing accuracy in object identification.

The capacitive touch device has a touch panel and a controller.

The touch panel has multiple traces.

The controller is connected to the traces of the touch panel, scans each trace to determine if sensing information generated by an touch object touching the touch panel, in which the sensing information includes a sensing cluster corresponding to a portion on the touch panel touched by the touch object and a hover cluster corresponding to a portion on the touch panel adjacent to but not in contact with the touch object and surrounding the sensing cluster, and identifies the touch object as a specific touch object when determining that the hover cluster meets a first characteristic.

The foregoing capacitive touch device employs the controller thereof to scan each trace to determine if a sensing cluster and a hover cluster located around the sensing cluster are available because of a touch object touching on the touch panel, and further determines if the touch object is a specific object depending on if the touch object is a specific object. Accordingly, palm rejection operation can be accurately performed to reject nonspecific touch object, such as a palm, to enhance the accuracy in object identification.

Other objectives, advantages and novel features of the invention will become more apparent from the following detailed description when taken in conjunction with the accompanying drawings.

### BRIEF DESCRIPTION OF THE DRAWINGS

FIG. 1 is a block circuit diagram of a capacitive touch panel in accordance with the present invention;

FIG. 2 is a schematic view of the capacitive touch panel in FIG. 1 upon reading sensing information;

FIG. 3 is a schematic view showing a contact area and a hover area formed between a finger and the capacitive touch panel in FIG. 1;

FIG. 4 is a schematic view showing a contact area and a hover area formed between a palm and the capacitive touch panel in FIG. 1;

FIG. 5 is another schematic view of the capacitive touch panel in FIG. 1 upon reading sensing information;

FIG. 6 is a flow diagram of a first embodiment of a method identifying touch object on a capacitive touch panel in accordance with the present invention;

FIG. 7 is a schematic view of the capacitive touch panel upon reading sensing information with a mutual-capacitance scanning approach and a self-capacitance scanning approach;

FIG. 8 is a flow diagram of a second embodiment of a method identifying touch object on a capacitive touch panel in accordance with the present invention;

FIG. 9 is a flow diagram of a third embodiment of a method identifying touch object on a capacitive touch panel in accordance with the present invention; and

FIGS. 10A and 10B are schematic views showing contact areas generated on a touch panel when a finger touches the touch panel with different degrees of force.

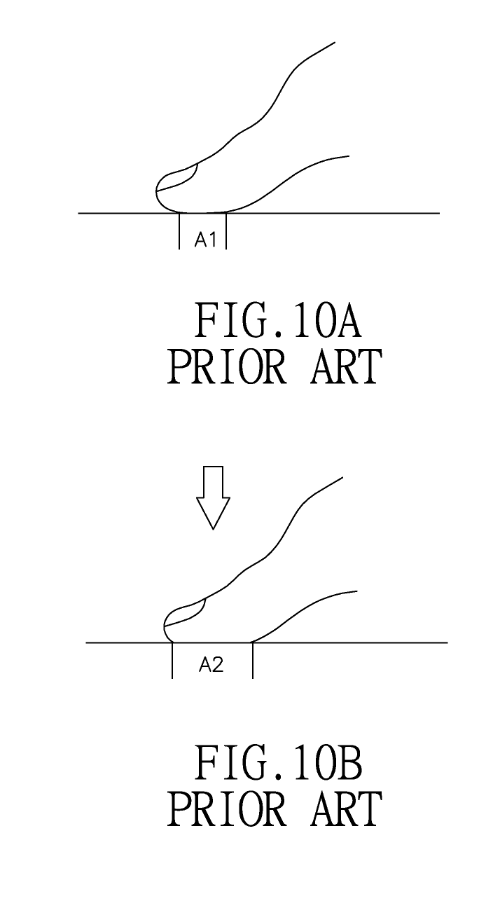

### DETAILED DESCRIPTION OF THE INVENTION

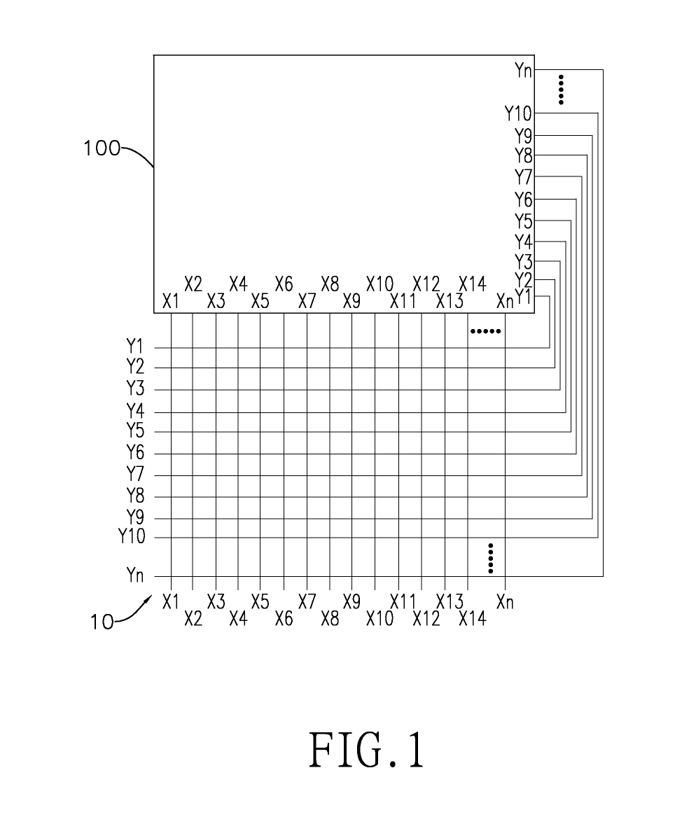

With reference to FIG. 1, a capacitive touch device in accordance with the present invention has a touch panel 10 and a controller 100. The touch panel 10 has multiple traces including multiple X-axis traces X1˜Xn and multiple Y-axis traces Y1˜Yn. Each X-axis trace X1˜Xn is perpendicularly intersected with the Y-axis traces Y1˜Yn, and a sensor node is constituted at each intersection of a corresponding X-axis trace X1˜Xn and a corresponding Y-axis trace Y1˜Yn. The controller 100 is connected to the X-axis traces X1˜Xn and the Y-axis traces Y1˜Yn, and scans each X-axis trace X1˜Xn and each Y-axis trace Y1˜Yn to read sensing information thereon.

As far as current scanning technique for touch panels is concerned, the controller 100 can employ a mutual-capacitance scanning approach or a self-capacitance scanning approach to read the sensing information on the X-axis traces X1˜Xn and the Y-axis traces Y1˜Yn. The mutual-capacitance scanning approach is carried out by the controller 100 to send out an excitation signal through each X-axis trace X1˜Xn or each Y-axis trace Y1˜Yn and read each sensing information on each Y-axis trace Y1˜Yn or each X-axis trace X1˜Xn. The self-capacitance scanning approach is also carried out by the controller 100 to send out excitation signals respectively through each X-axis trace X1˜Xn and each Y-axis trace Y1˜Yn and read the sensing information on the X-axis trace X1˜Xn and the Y-axis trace Y1˜Yn that send out the excitation signals. In the following embodiments, besides using the mutual-capacitance scanning approach to read sensing information, the controller 100 also combines the mutual-capacitance scanning approach and the self-capacitance scanning approach to read sensing information.

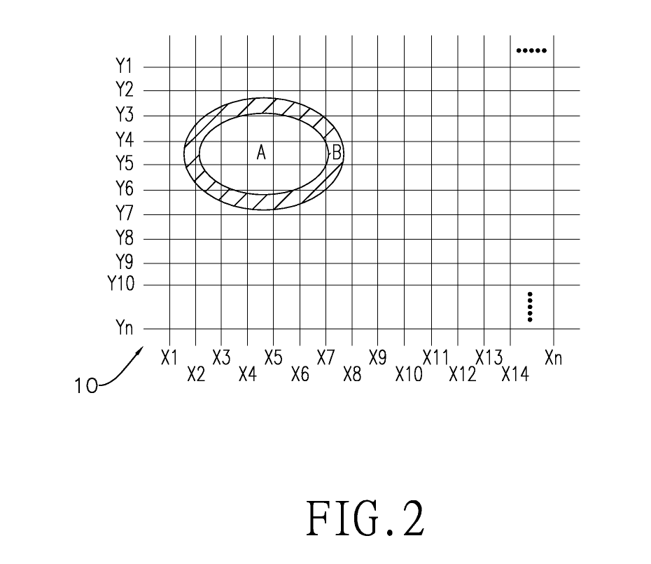

The controller 100 employs the mutual-capacitance scanning approach to read sensing information in the following embodiment. After reading sensing information of the touch panel 10, the controller 100 determines if a sensing cluster appears on the touch panel 10 according to the acquired sensing information when a touch object touches the touch panel 10. With reference to FIG. 2, the sensing cluster is composed of multiple sensor nodes with sensing capacitance values greater than a first sensing capacitance threshold. After determining that the sensing cluster A appears, the controller 100 further determines if a hover cluster B appears around the sensing cluster A according to the acquired sensing information.

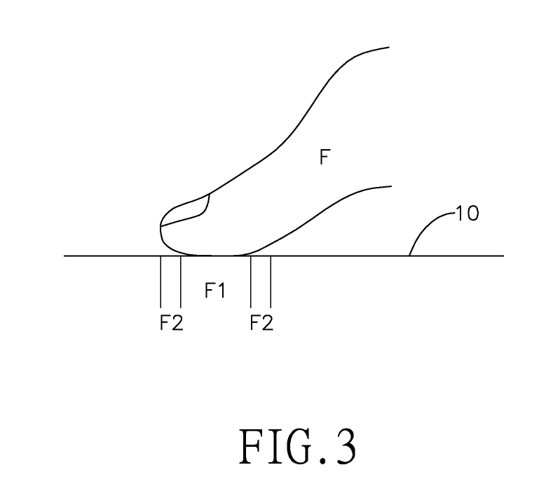

When there is a touch object touching the touch panel 10, besides a capacitance variation occurring at a portion of the touch panel 10 directly touched by the touch object, a capacitance variation also occurs at a portion of the touch panel 10 over which the touch object hovers. Multiple sensor nodes with variations in sensing capacitance value due to the hovering touch object and the sensing capacitance values of the multiple sensor nodes greater than a second sensing capacitance threshold and less than the first sensing capacitance threshold constitute the foregoing hover cluster. With reference to FIG. 3, when a finger F touches the touch panel 10, the finger F generates a contact area F1 and a hover area F2 on the touch panel 10. The contact area F1 corresponds to the sensing cluster A and the hover area F2 corresponds to the hover cluster B.

From the foregoing, by setting the first sensing capacitance threshold and the second sensing capacitance threshold with the first sensing capacitance threshold greater than the second sensing capacitance threshold, the sensing cluster A and the hover cluster B around the sensing cluster A can be defined when there is a touch object touching the touch panel 10. Hence, the hover cluster B has an inner boundary adjacent to the sensing cluster A and an outer boundary at an outer perimeter of the hover cluster B. The inner boundary represents the first sensing capacitance threshold and the outer boundary represents the second sensing capacitance threshold.

After determining that the hover cluster B appears, the controller 100 further determines if the hover cluster B meets a first characteristic. The first characteristic indicates a variation between the hover clusters B respectively generated when a finger and a palm touch the touch panel 10.

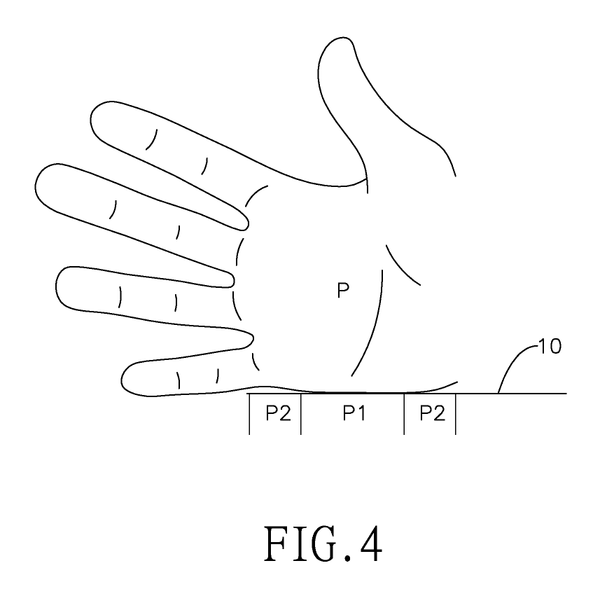

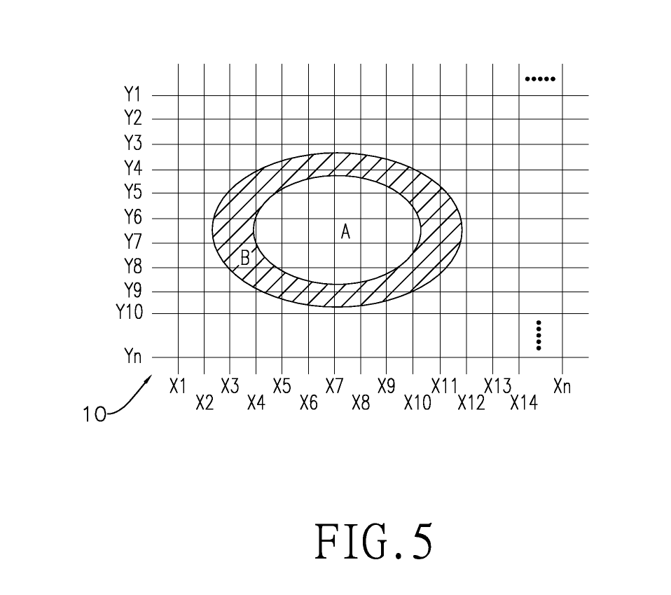

With reference to FIG. 3, when the finger F touches the touch panel 10, a distance between a skin of the finger pulp of the finger F and the touch panel 10 from an inner edge to an outer edge of the hover area F2 varies to a relatively greater extent because of finger structure. As can be seen from FIG. 2, the hover cluster B is relatively smaller in area or is relatively narrower between the inner boundary and the outer boundary thereof. With reference to FIG. 4, when a palm P touches the touch panel 10, a contact area P1 and a hover area P2 exist between a palm side of the palm P and the touch panel 10, and a distance between the palm side and the touch panel 10 from an inner edge to an outer edge of the hover area P2 varies to a relatively less extent. With reference to FIG. 5, the hover cluster B (area marked by slash lines) is relatively larger in area or relatively wider between the inner boundary and the outer boundary thereof. The controller 100 determines how the hover cluster B meets the first characteristic according to the differences specific to a finger or a palm.

A feasible way of determining if the hover cluster B meets the first characteristic is to read a sensing capacitance value of each sensor node on the touch panel using the mutual-capacitance scanning approach, and acquire the hover cluster B and a ratio of a difference between a sensing capacitance value at one of the sensor nodes on the inner boundary and a sensing capacitance value at one of the sensor nodes on the outer boundary to a distance between the inner boundary and the outer boundary. If the ratio (slope) of the difference to the distance is greater than a first configuration value, it represents that the first characteristic is met.

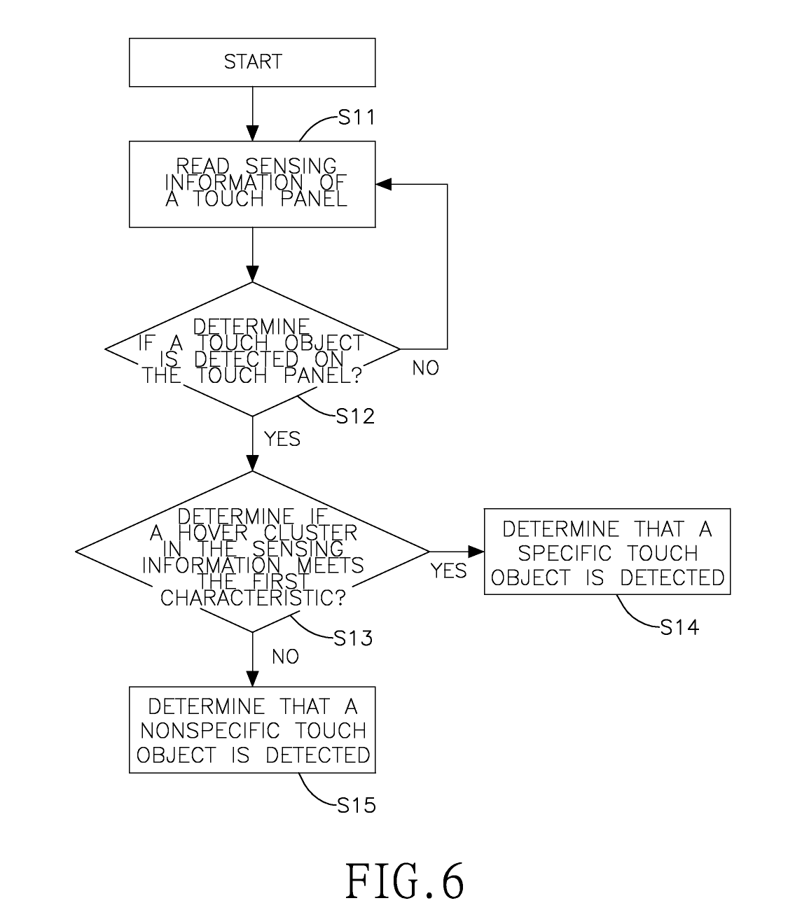

From the foregoing description, the comparison between touch events made by the finger F and the palm P indicates that the distance between the skin of the finger pulp of the finger F and the touch panel 10 from the inner edge to the outer edge of the hover area F2 varies to a relatively greater extent, and the variation between the sensing capacitance values and the distances of the sensor nodes on the inner boundary and the outer boundary of the hover cluster B is relatively greater or the slope (ratio) is greater. Thus, the controller 100 sets the first configuration value dedicated to the slope (ratio) and performs the following steps as shown in FIG. 6.

Step S11: Read sensing information of the touch panel 10.

Step S12: Determine if a touch object is detected on the touch panel 10. When the sensing information contains a sensing cluster, it represents that a touch object is detected.

Step S13: Determine if the hover cluster B in the sensing information meets the first characteristic. As mentioned, the criteria of determining that the hover cluster B meets the first characteristic resides in that the variation between the sensing capacitance values and the distances of the sensor nodes on the inner boundary and the outer boundary of the hover cluster B is greater than the first configuration value. If the variation is greater than the first configuration value, it represents that the first characteristic is met, and perform step S14. Otherwise, when the palm P touches the touch panel 10, the variation between the sensing capacitance values and the distances of the sensor nodes on the inner boundary and the outer boundary of the hover cluster B is relatively less and the slope (ratio) is relatively smaller such that the slope is less than the first configuration value and the first characteristic is therefore not met, and perform step S15.

Step S14: Determine that a specific touch object (a finger) is detected.

Step S15: Determine that a nonspecific touch object is detected and perform a palm rejection operation.

Another feasible way of determining if the hover cluster B meets the first characteristic is to acquire a distance of a portion covered by the hover cluster B in a first direction, determine if the distance is less than a second configuration value, and determine that the first characteristic is met if the distance is less than the second configuration value. It is the controller 100 that employs the mutual-capacitance scanning approach and the self-capacitance scanning approach to respectively read sensing information corresponding to the X-axis traces X1˜Xn and the Y-axis traces Y1˜Yn on the touch panel 10. As being capable of accurately position two-dimensional location of a touch object, the mutual-capacitance scanning approach is used to read a first distance of the sensing cluster A in the first direction. The self-capacitance scanning approach is advantageous in stronger SNR (Signal noise ratio) performance and has better sensitivity in sensing hovering touch object and is thus used to read a second distance of a portion covered by the outer boundary hover cluster B in the first direction. A difference between the first distance and the second distance is equal to a width of the hover cluster B in the first direction, and if the width of the hover cluster B is less than the second configuration value, it represents that a specific touch object (a finger) is detected. If the width of the hover cluster B is greater than the second configuration value, it represents that a palm rejection event occurs. Physical implementation as to how to determine palm rejection is described as follows.

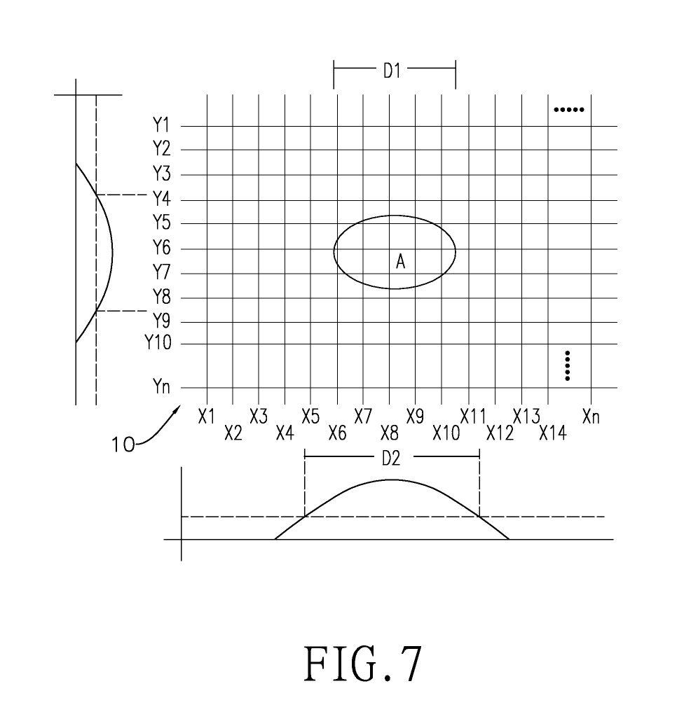

The first direction may be X axis or Y axis of the touch panel 10. Given Y axis as an example, the controller 100 uses the mutual-capacitance scanning approach to acquire all sensor nodes with the sensing capacitance values greater than the first sensing capacitance threshold. The sensor nodes with the sensing capacitance values greater than the first sensing capacitance threshold are further employed to calculate a first distance D1 of the sensing cluster A in the first direction. With reference to FIG. 7, as the sensing cluster A read by the mutual-capacitance scanning approach has the most sensing nodes with the sensing capacitance values greater than the first sensing capacitance threshold on the Y-axis trace Y6, the sensor nodes on the Y-axis trace Y6 are used to calculate the first distance D1, which is the maximum distance of the sensing cluster A.

On the other hand, the controller 100 uses the self-capacitance scanning approach to acquire sensing information (waveform of sensing capacitance values) on all X-axis traces and Y-axis traces. The X-axis traces and the Y-axis traces with the sensing capacitance values greater than the second sensing capacitance threshold are used to determine the outer boundary of the hover cluster B. The number of the X-axis traces and the Y-axis traces with the sensing capacitance values greater than the second sensing capacitance threshold are used to calculate a second distance D2 of an area covered by the hover cluster B in the first direction. With further reference to FIG. 7, the sensing cluster A read by the mutual-capacitance scanning approach has the maximum distance (first distance D1) on the Y-axis trace Y6, and when the self-capacitance scanning approach is used to read the sensing capacitance values of all the X-axis traces and the Y-axis traces, the Y-axis Y6 has the greatest sensing capacitance value as illustrated by a waveform of the sensing capacitance values on the left of the vertical axis in FIG. 7 and the sensing capacitance values read from the X-axis traces X5˜X11 corresponding to the Y-axis trace Y6 are all greater than the second sensing capacitance threshold as illustrated by a waveform of the sensing capacitance values below the horizontal axis in FIG. 7. Hence, the number of the X-axis traces X5˜X11 are used to calculate the second distance D2. As the Y-axis trace Y6 is intersected by the most X-axis traces with the sensing capacitance values greater than the second sensing capacitance threshold, the second distance D2 is the maximum distance of an area covered by the hover cluster B. A difference between the first distance D1 and the second distance D2 is taken as a distance between the inner boundary and the outer boundary of the hover cluster B. The difference is then compared with the second configuration value to determine if a specific touch object appears on the touch panel 10. When the self-capacitance scanning approach is used to read the sensing capacitance values of the X-axis traces and the Y-axis traces, a range of the hover cluster B is jointly determined by the number of the X-axis traces and the number of the Y-axis traces with the sensing capacitance values higher than specific sensing capacitance thresholds (as illustrated by waveforms on the right of the vertical axis and below the horizontal axis in FIG. 7).

According to actual measurements on regular touch panels, when the touch object is a finger, the first distance D1 is approximately in a range of 0.5 cm˜0.3 cm and the second distance D2 is approximately in a range of 0.5 cm˜3.5 cm. The second configuration value can be set to be in a range of 0.5 cm˜1 cm. When the first distance D1 exceeds 3 cm or the second distance D2 exceeds 4 cm, the area of the hover cluster B is determined to be greater than the condition being the specific touch object and a palm rejection operation is performed.

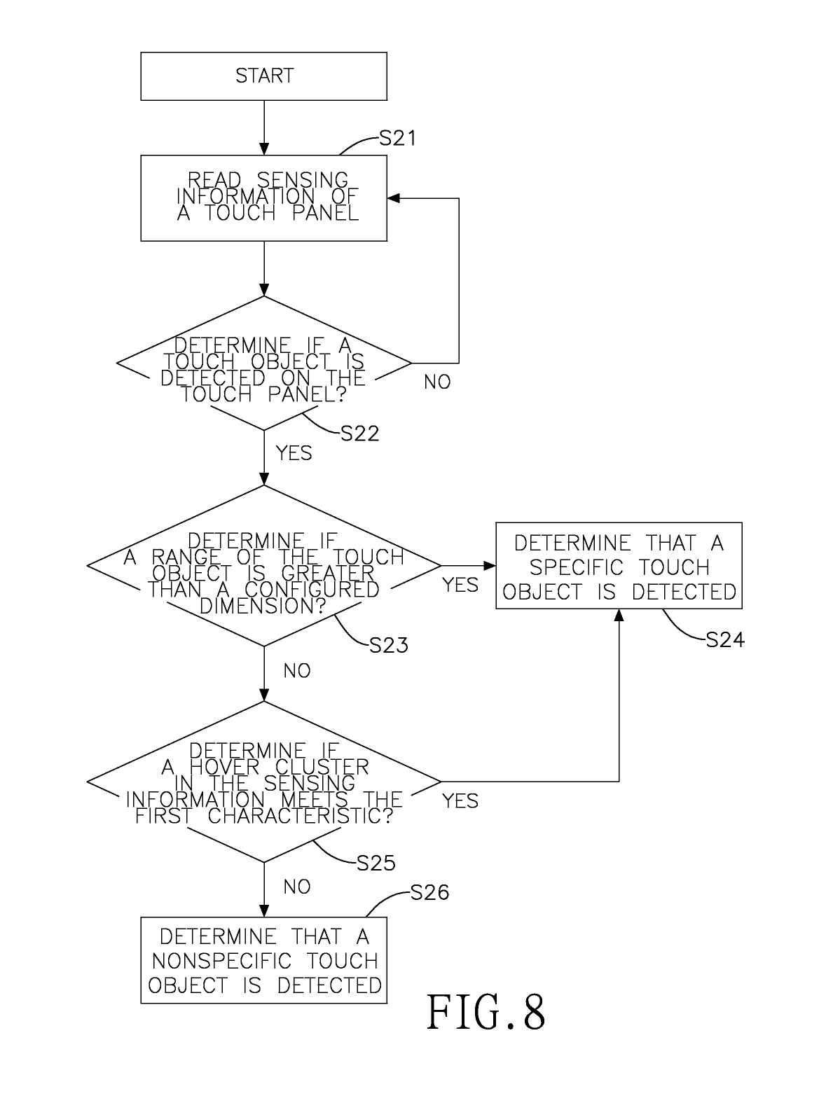

With reference to FIG. 8, according to the foregoing embodiments, the controller 100 performs the following steps.

Step S21: Read sensing information of the touch panel 10.

Step S22: Determine if a touch object is detected on the touch panel 10. If a touch object is detected on the touch panel 10, perform step S23. Otherwise, resume step S21.

Step S23: Determine if a range of the touch object is greater than a configured size. If the range of the touch object is greater than the configured size, perform step S24. Otherwise, perform step S25. In the present embodiment, determine if the first distance D1 of the sensing cluster A in the first direction is greater than a configuration value. For example, determine if the first distance D1 of the sensing cluster A in the first direction is greater than 3 cm or the second distance D2 of the hover cluster B is greater than 4 cm.

Step S24: Determine that the touch object is a nonspecific touch object.

Step S25: Determine if the hover cluster B of the sensing information meets the first characteristic. If the hover cluster B meets the first characteristic, perform step S26. Otherwise, resume step S24. The first characteristic represents that the difference between the first distance D1 and the second distance D2 is less than the second configuration value.

Step S26: Determine that the touch object is a specific touch object.

Step S27: If the hover cluster meets the first characteristic, perform step S26. Otherwise, resume step S24.

As can be seen from the foregoing embodiments, the touch panel 10 in accordance with the present invention can effectively analyze the characteristics of the hover cluster B, which are taken as the basis of rejecting nonspecific touch object, such as a palm. When determining that the touch object is a nonspecific touch object (a palm), the controller 100 performs a first operation command, which may perform a palm rejection operation to ignore report of sensing capacitance values or perform other operation. When determining that the touch object is a specific touch object (a finger), the controller 100 performs a second operation command, which may perform an application or may correspond to a click, a pick or other gesture.

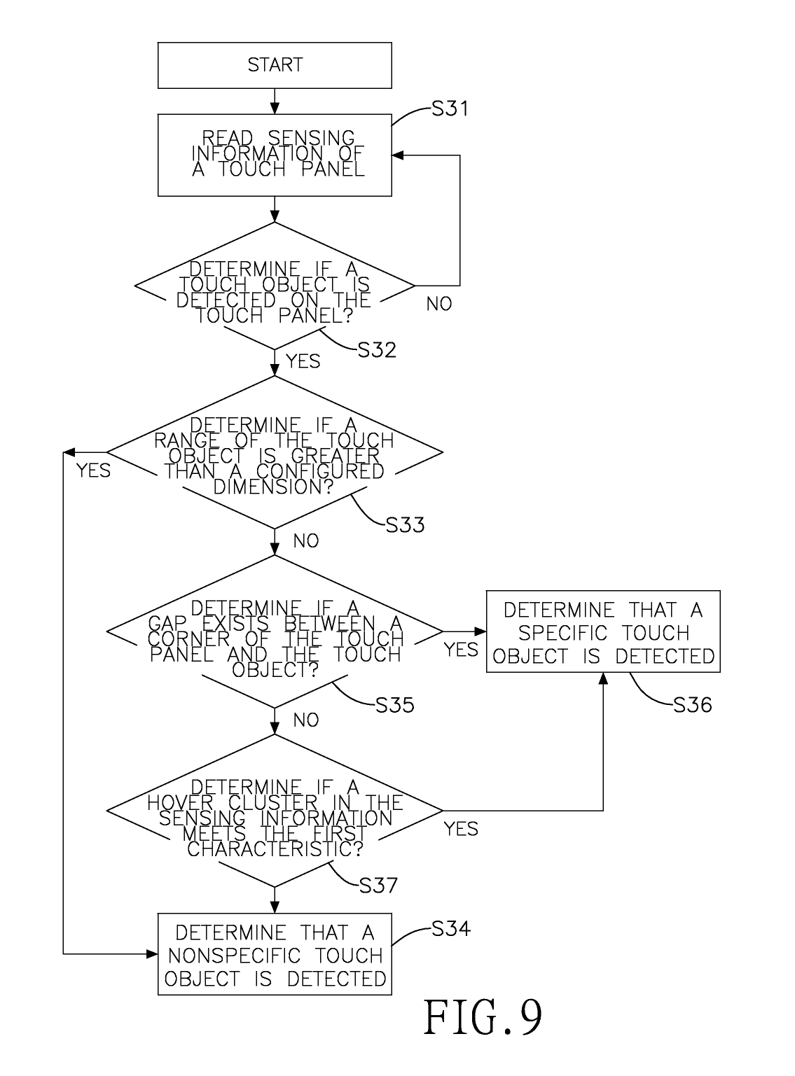

Another embodiment is given as follows to further utilize the foregoing techniques to perform palm rejection as a result of a nonspecific touch object appearing on a corner or a perimeter of the touch panel 10. When a touch object is located at a corner of the touch panel 10, the sensing information of the touch object received by the touch panel 10 is rather incomplete and the incomplete information easily causes false determination of touch event. For example, when a palm is located at a corner of a touch panel 10, the palm only partially contacts the touch panel 10 while the remaining portion of the palm is located outside the touch panel 10. As only a part of the palm is sensed, the palm is easily mistaken as a finger. To get rid of the false determination of a touch object on the corner or the perimeter of the touch panel 10, the controller 100 performs the following steps as shown in FIG. 9.

Step S31: Read sensing information of the touch panel 10.

Step S32: Determine if a touch object is detected on the touch panel 10. If a touch object is detected on the touch panel 10, perform step S33. Otherwise, resume step S31.

Step S33: Determine if a range of the touch object is greater than a configured dimension. If the range of the touch object is greater than the configured dimension, perform step S34. Otherwise, perform step S35. In the present embodiment, determine if the touch object is greater than a configured area.

Step S34: Determine that the touch object is a nonspecific touch object. In the present embodiment, determine if the touch object is greater than a configured area.

Step S35: Determine if a gap exists between a corner of the touch panel and the touch object. If a gap exists, perform step S36. Otherwise, perform step S37.

Step S36: Determine that the touch object is a specific touch object.

Step S37: Determine if a hover cluster of the sensing information meets the first characteristic. If the hover cluster meets the first characteristic, perform step S36. Otherwise, resume step S38.

Step S38: Determine that the touch object is a nonspecific touch object.

The concept of Step S35 is based upon that the phenomenon of a gap existing between a touch object and a corner of the touch panel 10 easily occurs only when a specific touch object (a finger) touches the corner. Additionally, prior to step S35 for determining the gap existence, the present invention first performs step S34 to determine if size of the touch object is greater than the configured area to rule out the condition of an area with a size of a palm on the touch panel 10. However, the condition of a palm partially touching a corner or a perimeter of the touch panel 10 still fails to be eliminated. Under such circumstance, as the palm normally fully covers a portion between the perimeter of the touch panel 10 and an enclosure surface of the electronic device, variation of sensing capacitance at a corner or an edge portion of the touch panel 10 still exists. In contrast to a palm, if a finger is located on a corner or an edge portion of the touch panel 10, it is difficult for the finger to cover both perimeter of the touch panel 10 and the enclosure surface of the electronic device because of a relatively smaller area covered by the finger. Thus, if step S35 determines that a gap exists between a touch object and a corner of the touch panel 10, the touch object can be determined as a specific touch object (a finger). The gap exists when there is at least one sensor node or trace having no sensing capacitance value or having sensing capacitance value lower than a critical value between the sensing cluster and a corner of the touch panel. The critical value may be the second sensing capacitance threshold. Same concept can be applied to detection of touch object adjacent to the perimeter of the touch panel 10. As a touch object may be simultaneously adjacent to two edges of the touch panel 10, the perimeter here indicates one of the edges of the touch panel 10 more adjacent to the sensing cluster.

In sum, the capacitive touch panel and the method identifying touch object on the touch panel analyze characteristics between the sensing cluster and the hover cluster generated by a touch object on the touch panel instead of size of the touch object for objection detection to determine if the touch object is a specific touch object. Since the touch object detection does not rely on the size of the touch object, the present invention is not subject to the issue of different contact areas of touch objects varying from person to person. Meanwhile, the present application focuses on analysis of characteristics associated with the hover cluster and determines a touch object as a specific touch object only when the characteristic condition is met, thereby enhancing the accuracy of object detection.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A method identifying touch object on a capacitive touch device, comprising steps of:
reading sensing information of multiple traces of a touch panel of a capacitive touch device corresponding to a touch object, wherein the sensing information includes a sensing cluster corresponding to a portion on the touch panel touched by the touch object;
identifying a hover cluster of the sensing information, wherein the hover cluster corresponds to a portion on the touch panel adjacent to but not in contact with the touch object and surrounds the sensing cluster;
determining if the hover cluster meets a first characteristic; and
determining that the touch object is a specific touch object when the hover cluster meets the first characteristic.

2. The method as claimed in claim 1, wherein the sensing information is acquired through a mutual-capacitance scanning approach.

3. The method as claimed in claim 1, wherein the sensing cluster of the sensing information is acquired through a mutual-capacitance scanning approach, and the hover cluster of the sensing information is acquired through a self-capacitance scanning approach.

4. The method as claimed in claim 1, wherein
the traces of the touch panel include multiple X-axis traces and multiple Y-axis traces, and the hover cluster has an inner boundary adjacent to the sensing cluster and an outer boundary at an outer perimeter of the hover cluster; and
the step of determining if the hover cluster meets the first characteristic further has steps of:
calculating a ratio of a difference between a sensing capacitance value on the inner boundary and a sensing capacitance value on the outer boundary to a distance between the inner boundary and the outer boundary; and
determining that the hover cluster meets the first characteristic if the ratio is greater than a first configuration value.

5. The method as claimed in claim 4, wherein
a sensor node is constituted at an intersection of each X-axis trace and a corresponding Y-axis trace; and
the step of determining if the hover cluster meets the first characteristic has steps of:
calculating a ratio of a difference between a sensing capacitance value at one of the sensor nodes on the inner boundary and a sensing capacitance value at one of the sensor nodes on the outer boundary to a distance between the inner boundary and the outer boundary; and
determining that the hover cluster meets the first characteristic if the ratio is greater than a first configuration value.

6. The method as claimed in claim 1, wherein the step of determining if the hover cluster meets the first characteristic further has steps of:
acquiring a distance of a portion of the touch panel covered by the hover cluster in a first direction; and
determining that the hover cluster meets the first characteristic if the distance is less than a second configuration value.

7. The method as claimed in claim 6, wherein
the traces of the touch panel include multiple X-axis traces and multiple Y-axis traces, and a sensor node is constituted at an intersection of each X-axis trace and a corresponding Y-axis trace; and
the distance is obtained according to a count of the sensor nodes on one of the X-axis traces with sensing capacitance values greater than a second sensing capacitance threshold and less than a first sensing capacitance threshold or a count of the sensor nodes on one of the Y-axis traces with sensing capacitance values greater than a second sensing capacitance threshold and less than a first sensing capacitance threshold.

8. The method as claimed in claim 6, wherein the step of determining if the hover cluster meets the first characteristic further has steps of:
acquiring a maximum distance of a portion of the touch panel covered by the hover cluster in a first direction; and
determining that the hover cluster meets the first characteristic if the maximum distance is less than the second configuration value.

9. The method as claimed in claim 6, wherein the second configuration value ranges from 0.5 cm to 1 cm.

10. The method as claimed in claim 1, further comprising steps of:
determining if a range of the touch object is greater than a configured size; and
determining that the touch object is a nonspecific touch object if the range of the touch object is greater than the configured size.

11. The method as claimed in claim 1, wherein
the traces of the touch panel include multiple X-axis traces and multiple Y-axis traces, and a sensor node is constituted at an intersection of each X-axis trace and a corresponding Y-axis trace; and
the method further comprises a step of determining if a gap exists between a perimeter of the touch panel and the sensing cluster.

12. The method as claimed in claim 11, wherein the gap exists when there is at least one of the sensor nodes or at least one of the traces having no sensing capacitance value or having sensing capacitance value lower than a critical value between the sensing cluster and the perimeter of the touch panel.

13. The method as claimed in claim 12, wherein the perimeter is one of edges of the touch panel most adjacent to the sensing cluster.

14. The method as claimed in claim 10, wherein
the traces of the touch panel include multiple X-axis traces and multiple Y-axis traces, and a sensor node is constituted at an intersection of each X-axis trace and a corresponding Y-axis trace; and
the method further comprises a step of determining if a gap exists between a corner of the touch panel and the sensing cluster.

15. The method as claimed in claim 14, wherein the gap exists when there is at least one of the sensor nodes or at least one of the traces having no sensing capacitance value or having sensing capacitance value lower than a critical value between the sensing cluster and the corner of the touch panel.

16. A capacitive touch device, comprising:
a touch panel having multiple traces; and
a controller connected to the traces of the touch panel, scanning each trace to determine sensing information generated by a touch object touching the touch panel, wherein the sensing information includes a sensing cluster corresponding to a portion on the touch panel touched by the touch object and a hover cluster corresponding to a portion on the touch panel adjacent to but not in contact with the touch object and surrounding the sensing cluster, and the controller identifies the touch object as a specific touch object when determining that the hover cluster meets a first characteristic.

17. The capacitive touch device as claimed in claim 16, wherein
the traces of the touch panel include multiple X-axis traces and multiple Y-axis traces, and a sensor node is constituted at an intersection of each X-axis trace and a corresponding Y-axis trace; and
the controller configures a first sensing capacitance threshold to determine an outer boundary of the hover cluster and configures a second sensing capacitance threshold to determine an inner boundary of the hover cluster.

18. The capacitive touch device as claimed in claim 17, wherein the controller calculates a ratio of a difference between a sensing capacitance value on the inner boundary and a sensing capacitance value on the outer boundary to a distance between the inner boundary and the outer boundary, and determines that the hover cluster meets the first characteristic if the ratio is greater than a first configuration value.

19. The capacitive touch device as claimed in claim 17, wherein the controller acquires a distance of a portion of the touch panel covered by the hover cluster in a first direction, and determines that the hover cluster meets the first characteristic if the distance is less than a second configuration value.

20. The capacitive touch device as claimed in claim 19, wherein the distance is obtained according to one of a count of the sensor nodes on one of the X-axis traces or on the Y-axis traces or a count of the X-axis traces and the Y-axis traces with sensing capacitance values greater than a second sensing capacitance threshold and less than a first sensing capacitance threshold.

21. The capacitive touch device as claimed in claim 16, wherein when determining that the touch object is not a specific touch object, the controller performs a first operation command.

22. The capacitive touch device as claimed in claim 21, wherein the first operation command is a palm rejection operation.

23. The capacitive touch device as claimed in claim 16, wherein when determining that the touch object is a specific touch object, the controller performs a second operation command.

24. The capacitive touch device as claimed in claim 23, wherein the second operation command is a click or a pick gesture.
